(19) United States
(12) Patent Application Publication
(10) Pub. No.: US 2020/0134771 A1
(43) Pub. Date: Apr. 30, 2020

(54) IMAGE PROCESSING METHOD, CHIP, PROCESSOR, SYSTEM, AND MOBILE DEVICE

(71) Applicant: SZ DJI TECHNOLOGY CO., LTD., Shenzhen (CN)

(72) Inventors: Jin XIE, Shenzhen (CN); Mingming GAO, Shenzhen (CN); Kang YANG, Shenzhen (CN)

(21) Appl. No.: 16/728,832

(22) Filed: Dec. 27, 2019

Related U.S. Application Data
(63) Continuation of application No. PCT/CN2017/094289, filed on Jul. 25, 2017.

(51) Int. Cl. G06T 1/00

(52) U.S. Cl. CPC G06T 1/0007

(57) ABSTRACT

An image processing method comprising acquiring a plurality of pixel rows of an image according to a rectangular pixel region, and storing the plurality of pixel rows as blocks in a plurality of line buffers. A pixel row is stored as a block in a storage space of the plurality of line buffers, and a number of bits of the block in a line buffer is smaller than a number of pixel columns of the image.

### CROSS-REFERENCE TO RELATED APPLICATION

This application is a continuation application of International Application No. PCT/CN2017/094289, filed on Jul. 25, 2017, the entire contents of which are incorporated herein by reference.

### TECHNICAL FIELD

The present disclosure relates to the field of information technology and, more particularly, to an image processing method, a chip, a processor, a computer system, and a mobile device thereof.

### BACKGROUND

Currently in the design and implementation of a field-programmable gate array (FPGA) or an application specific integrated circuit (ASIC) chip, the main power consumption and area are generated by random access memory (RAM). When the area of the RAM is small, the power consumption and area of the corresponding system will be small.

In existing technologies, various algorithms, such as Harris algorithm and Census algorithm, are usually implemented separately, i.e., a separate buffer is provided for each algorithm. When an image is processed by an algorithm, multiple rows of pixels of the image need to be read from a corresponding buffer, and the corresponding pixels are selected. Because the pixels are read from the buffer in entire lines, the read speed may be affected, especially for large-sized images, the processing efficiency may be significantly degraded.

Thus, how to improve processing efficiency has become an urgent technical problem in chip design.

### SUMMARY

In accordance with the disclosure, there is provided an image processing method. The method comprises acquiring a plurality of pixel rows of an image according to a rectangular pixel region, and storing the plurality of pixel rows as blocks in a plurality of line buffers. A pixel row is stored as a block in a storage space of the plurality of line buffers, and a number of bits of the block in a line buffer is smaller than a number of pixel columns of the image.

Also, in accordance with the disclosure, there is provided a chip. The chip comprises a controller and a plurality of line buffers. The controller is configured to acquire a plurality of pixel rows of an image according to a rectangular pixel region, and store the plurality of pixel rows as blocks in a plurality of line buffers. A pixel row is stored as a block in a storage space of the plurality of line buffers, and a number of bits of the block in a line buffer is smaller than a number of pixel columns of the image.

Also, in accordance with the disclosure, there is provided a processor. The processor comprises a chip. The chip comprises a controller and a plurality of line buffers. The controller is configured to acquire a plurality of pixel rows of an image according to a rectangular pixel region, and store the plurality of pixel rows as blocks in a plurality of line buffers. A pixel row is stored as a block in a storage space of the plurality of line buffers, and a number of bits of the block in a line buffer is smaller than a number of pixel columns of the image.

### BRIEF DESCRIPTION OF THE DRAWINGS

FIG. 1 is an architecture diagram of a technical solution according to an embodiment of the disclosure.

FIG. 2 is a processing architecture diagram of a technical solution according to an embodiment of the present disclosure.

FIG. 3 is an architecture diagram of a mobile device according to an embodiment of the present disclosure.

FIG. 4 is a flowchart of an image processing method according to an embodiment of the present disclosure.

FIG. 5 is a schematic diagram of a storage design of line buffers according to an embodiment of the present disclosure.

FIG. 6 is flowchart of an image processing method according to another embodiment of the present disclosure.

FIG. 7 is a block diagram of a chip according to an embodiment of the present disclosure.

FIG. 8 is a block diagram of a chip according to another embodiment of the present disclosure.

FIG. 9 is a block diagram of a chip according to another embodiment of the present disclosure.

FIG. 10 is a block diagram of a computer system according to an embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be understood that sequence numbers of the foregoing processes do not mean execution sequences in the embodiments of the present disclosure. The execution sequences of the processes should be determined according to functions and internal logic of the processes, and should not be construed as any limitation on the implementation processes of the embodiments of the present disclosure.

It should be understood that the various embodiments described in the specification may be implemented separately or in combination, which is not limited by the present disclosure.

The technical solution provided by the present disclosure may be applied to various algorithms, such as Harris algorithm or Census algorithm, which is not limited by the present disclosure.

The technical solution provided by the present disclosure stores multiple rows of pixels of an image as blocks in line buffers, which may improve the reading-out speed of pixels from the line buffers and, accordingly, improve the processing efficiency.

Further, the technical solution provided by the present disclosure may allow a plurality of algorithms to share line buffers, such that a separate buffer may be no longer provided to each algorithm, thereby reducing the consumption of storage resources.

In the disclosed embodiments, a rectangular pixel region may be the smallest rectangular pixel region for the pixel selection in the algorithm, i.e., a window for the pixel selection in the algorithm. It should be understood that when the window for the pixel selection in the algorithm is not a rectangular area, the rectangular pixel region may be the smallest rectangular pixel region which covers the window. The number of rows of the rectangular pixel region may be the same as or different from the number of columns of the rectangular pixel region. For example, for Harris algorithm, the rectangular pixel region may be a 3×3 pixel region, while for the Census algorithm, the rectangular pixel region may be a 13×13 pixel region.

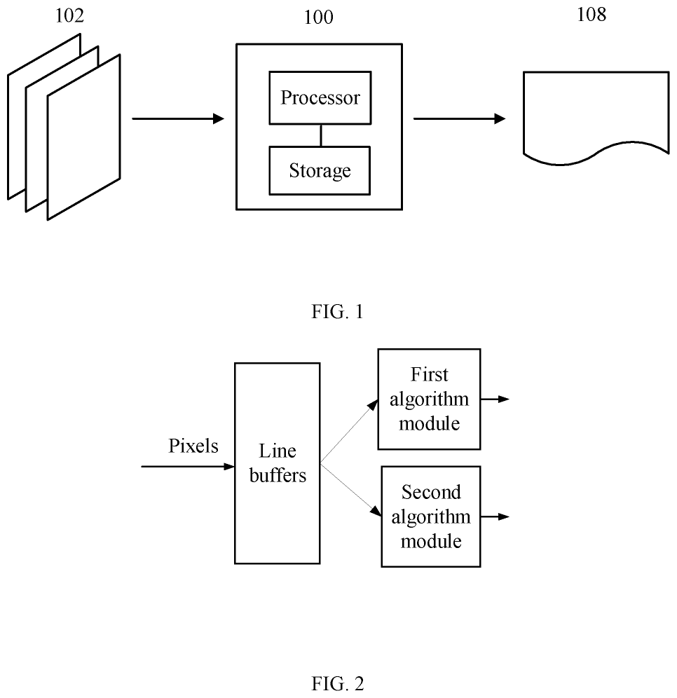

FIG. 1 is an architecture diagram of a technical solution according to an embodiment of the disclosure. As shown in FIG. 1, a system 100 may receive data to be processed 102, process the data to be processed 102, generate processed data 108, and output the processed data 108. In some embodiments, components in the system 100 may be implemented by one or more processors, which may include processors in a computing device or processors in a mobile device (e.g., a drone). The processors may be any appropriate processors, which is not limited by the present disclosure. In some embodiments, the processor may be a chip comprising a buffer and processing circuitry (which is also referred to as controller). In some embodiments, the system 100 may further include one or more storages configured to store instructions and data, such as computer executable instructions to implement the technical solution of the embodiments of the present disclosure, the data to be processed 102, and the processed data 108, etc. For example, the storage may include a buffer or memory. The storage may be any appropriate storage, which is not limited by the present disclosure.

The data to be processed 102 may include data of an image (i.e., image data), or other similar multimedia data. In some embodiments, the data to be processed 102 may include sensing data from a sensor, which may be a vision sensor (e.g., a camera, an infrared sensor), a near field sensor (e.g., an ultrasonic sensor, a radar), and/or a position sensor, etc. In some embodiments, the data to be processed 102 may include information of a user (i.e., user information), such as biometric information including facial features, fingerprints, retinal information, and/or DNA samples, etc. In the disclosed embodiments, the image data is taken as an example, but the present disclosure is not limited thereto.

FIG. 2 is a processing architecture diagram of a technical solution according to an embodiment of the present disclosure. As shown in FIG. 2, a plurality of rows of pixels of an image may be input into line buffers. The line buffers may be configured to store a maximum number of rows of data (e.g., pixels) which is to be stored in the calculation process of at least one algorithm. For example, in FIG. 2, the first algorithm may be Census algorithm, and the second algorithm may be Harris algorithm, but the embodiment of the present disclosure is not limited thereto. The Harris algorithm may need to store 3 rows of data, and the Census algorithm may need to store 12 rows of data, then the line buffers may be the storage space for the 12 rows of data of the image. That is, in the disclosed embodiments, multiple algorithms may share the line buffers, such that separate line buffers may be no longer desired to be provided for each algorithm, which reduces the consumption of the storage resources.

In some embodiments, a mobile device, which is also referred to as a portable device, may process data using the technical solution provided by the present disclosure. The mobile device may be a drone, an unmanned boat, an autonomous vehicle, or a robot, etc., which is not limited by the present disclosure.

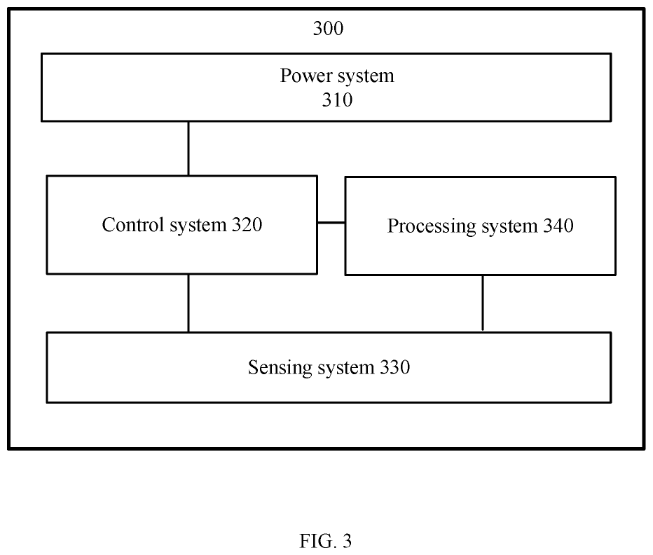

FIG. 3 is an architecture diagram of a mobile device 300 according to an embodiment of the present disclosure. As shown in FIG. 3, the mobile device 300 may include a power system 310, a control system 320, a sensing system 330, and a processing system 340. The power system 310 may be configured to provide power to the mobile device 300. Taking the drone as an example, the power system of the drone may include an electronic speed control (ESC), a propeller, and a motor corresponding to the propeller. The motor may be coupled between the ESC and the propeller, and the motor and the propeller may be mounted at the corresponding arms. The ESC may be configured to receive the driving signal generated by the control system, and based on the driving signal, provide a driving current to the motor to control the rotating speed of the motor. The motor may be configured to drive the propeller to rotate, thereby providing flight power to the drone.

The sensing system 330 may be configured to measure posture information of the mobile device 300, i.e., position information and status information of the mobile device 300 in space, such as three-dimensional (3D) position, 3D angle, 3D speed, 3D acceleration, and/or 3D angular velocity, etc. The sensing system 330 may include, for example, at least one of a gyroscope, an electronic compass, an inertial measurement unit (IMU), a vision sensor, a global positioning system (GPS), a barometer, and/or an airspeed meter.

In one embodiment, the sensing system 330 may be further configured to acquire images, i.e., the sensing system 330 may include a sensor for acquiring images, such as a camera. The control system 320 may be configured to control the movement of the mobile device 300. The control system 320 may control the mobile device 300 in accordance with preset program instructions. For example, the control system 320 may control the movement of mobile device 300 based on the posture information of mobile device 300 measured by sensing system 330. The control system 320 may also control the mobile device 300 based on the control signals from a remote control. For example, for a drone, the control system 320 may be a flight control system or a control circuit in the flight control system.

The processing system 340 may be configured to process images acquired by the sensing system 330. For example, the processing system 340 may include an image signal processing (ISP) chip. In one embodiment, the processing system 340 may be the system 100 in FIG. 1, in another embodiment, the processing system 340 may include the system 100 in FIG. 1.

It should be understood that the above-mentioned divisions and naming of the components of the mobile device 300 are merely for illustrative purposes, which is not intended to limit the scope of the present disclosure. In addition, the mobile device 300 may further include other components which are not drawn in FIG. 3.

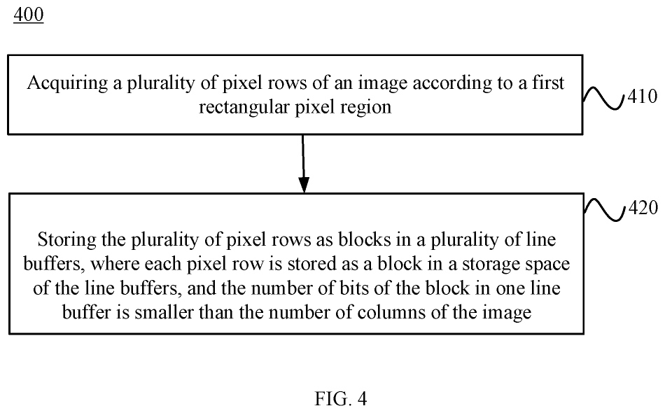

FIG. 4 is a flowchart of an image processing method 400 according to an embodiment of the present disclosure. The method 400 may be executed by the system 100 shown in FIG. 1 or the mobile device 300 shown in FIG. 3. In particular, when executed by the mobile device 300, the method may be executed by the processing system 340 in FIG. 3. As shown in FIG. 4, the image processing method 400 may include the following steps.

First, a plurality of rows of pixels of (i.e., a plurality of pixel rows) of an image are acquired according to a first rectangular pixel region (Step 410). In particular, the pixels used for follow-on algorithm processing may be acquired according to the first rectangular pixel region. The pixel may be a pixel output by a module of a preceding stage algorithm, or a pixel stored in the memory.

In one embodiment, the number of the acquired pixel rows may be not less than a difference between the number of pixel rows of the first rectangular pixel region and a preset value. The preset value may be 1 or other values. In one embodiment, the number of the acquired pixel rows may be equal to a difference between the number of pixel rows of the first rectangular pixel region and the preset value. For example, the number of the acquired pixel rows may be equal to the number of pixel rows of the first rectangular pixel region minus one. That is, when the first rectangular pixel region is a 13×13 pixel region, the number of the acquired pixel rows may be 12. Then the acquired pixel rows may be stored in line buffers for the algorithm to be processed.

After the plurality of pixel rows of the image are acquired, the plurality of acquired pixel rows are stored as blocks in a plurality of line buffers, where each pixel row is stored as a block in a storage space of the plurality of line buffers, and the number of bits of the block in one line buffer is smaller than the number of pixel columns of the image (S420).

In the disclosed embodiments, the plurality of acquired pixel rows may be stored as blocks in a plurality of line buffers. In other words, the plurality of acquired pixel rows may be no longer stored as rows, instead the plurality of acquired pixel rows may be stored as blocks in the plurality of line buffers, where each pixel row is stored as a block in a storage space of the plurality of line buffers. That is, each of acquired pixel rows of the image may occupy one block in the storage space of the plurality of lines buffers instead of occupying one line buffer. The number of bits per block in a line buffer may be smaller than the number of pixel columns of the image. Thus, the number of pixel columns to be read from the line buffer may be smaller than the number of pixel columns of the image, such that the read speed may be increased, and the processing efficiency may be improved accordingly.

In one embodiment, when storing a plurality of pixel rows as blocks in the line buffers, a requirement of a plurality of rectangular pixel regions may be considered. For example, the plurality of pixel rows may be stored as blocks in a plurality of line buffers according to a first rectangular pixel region and a second rectangular pixel region.

In particular, after acquiring a plurality of pixel rows of an image according to the first rectangular pixel region, the plurality of acquired pixel rows may be stored as blocks in a plurality of line buffers according to the second rectangular pixel region and the first rectangular pixel region. That is, two rectangular pixel regions may be considered when storing the acquired pixel rows. In one embodiment, the second rectangular pixel region may have a smaller number of pixel rows than the first rectangular pixel region. That is, the pixels may be acquired according to a rectangular pixel region having a large number of pixel rows, and the acquired pixels may be stored in the line buffers according to both the rectangular pixel region having a large number of pixel rows and the rectangular pixel region having a small number of pixel rows.

In one embodiment, the number of blocks in one column of the plurality of line buffers may be equal to the number of pixel rows of the second rectangular pixel region. That is, the number of blocks in the vertical direction of the storage space formed by the plurality of line buffers may be equal to the number of pixel rows of the second rectangular pixel region. For example, when the second rectangular pixel region is a 3×3 pixel region, the number of blocks in the vertical direction may be three. In another embodiment, the number of blocks in the vertical direction of the storage space formed by the plurality of line buffers may be different from the number of pixel rows of the second rectangular pixel region.

In one embodiment, the number of bits of one block (i.e., the horizontal width of one block) in one of the plurality of line buffers may be not less than the number of pixel columns of the second rectangular pixel region. For example, when the second rectangular pixel region is a 3×3 pixel region, the horizontal width of one block may be not less than 3. In another embodiment, the number of bits of one block (i.e., the horizontal width of one block) in one of the plurality of line buffers may be smaller than the number of pixel columns of the second rectangular pixel region.

A product of the number of blocks in one column of the plurality of line buffers (i.e., in the vertical direction of the storage space of the plurality of line buffers) and the number of blocks in one line buffer (i.e., in the horizontal direction of the storage space of the plurality of line buffers) may be not less than the difference between the number of pixel rows of the first rectangular pixel region and a preset value. That is, the product of the number of blocks in the vertical direction of the storage space and the number of blocks in the horizontal direction of the storage space may be not less than a value associated with the number of pixel rows of the first rectangular pixel region. The value associated with the number of pixel rows of the first rectangular pixel region may be the difference between the number of pixel rows of the first rectangular pixel region and the preset value, and the preset value may be 1 or other values. For example, when the first rectangular pixel region is a pixel region of 13×13, the product of the number of blocks in the vertical direction of the storage space of the plurality of line buffers and the number of blocks in the horizontal direction of the storage space of the plurality of line buffers may be not less than 12.

In one embodiment, the product of the number of blocks in one column of the plurality of line buffers and the number of blocks in one line buffer may be equal to the number of pixel rows of the first rectangular pixel region minus one. That is, the product of the number of blocks in the vertical direction of the storage space of the plurality of line buffers and the number of blocks in the horizontal direction of the storage space of the plurality of line buffers may be equal to the number of pixel rows of the first rectangular pixel region minus one. For example, when the first rectangular pixel region is a pixel region of 13×13, the product of the number of blocks in the vertical direction of the storage space of the plurality of line buffers and the number of blocks in the horizontal direction of the storage space of the plurality of line buffers may be equal to 12.

In one embodiment, the plurality of pixel rows may be sequentially stored as a plurality of blocks, in an order from top to bottom and from left to right in the storage space of the plurality of line buffers. That is, the plurality of blocks corresponding to the plurality of acquired pixel rows may be arranged in an order from top to bottom and from left to right. It should be understood that the storage order of the blocks may vary, for example, the blocks may be arranged in an order from left to right and from top to bottom in the storage space of the plurality of line buffers, which is not limited by the present disclosure.

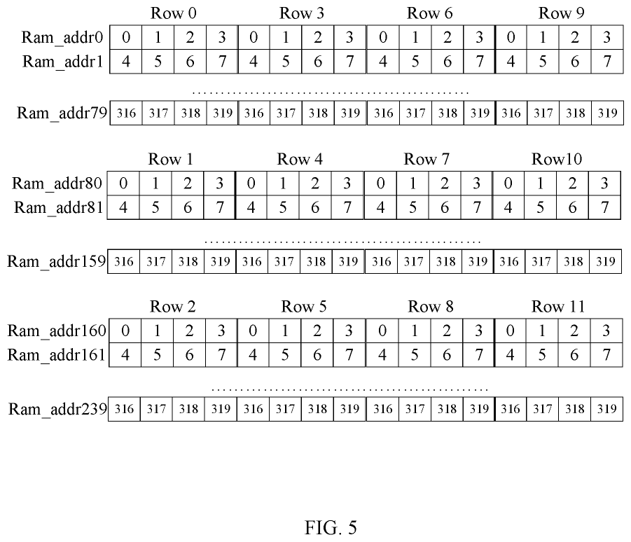

FIG. 5 is a schematic diagram of a storage design of line buffers according to an embodiment of the present disclosure. As shown in FIG. 5, the first rectangular pixel region is a pixel region of 13×13, and the second rectangular pixel region is a pixel region of 3×3. According to the first rectangular pixel region, 12 pixel rows of the image may be acquired. In the acquired 12 pixel rows, each pixel row may be stored as a block in the storage space of a plurality of line buffers.

As shown in FIG. 5, row 0 to row 11 respectively represents the acquired 12 pixel rows of the image, and each pixel row is stored as one block. That is, the acquired 12 pixel rows are stored as 12 blocks in the storage space of the plurality of line buffers. The blocks corresponding to the acquired 12 pixel rows are arranged in an order from top to bottom and left to right. The number of bits of one block in one line buffer is 4, which is greater than the number of pixel columns of the second rectangular pixel region. The line buffer may have a bit width of 16, and the number of blocks in one line buffer (i.e., in the horizontal direction) is 4. The number of blocks in one column of the plurality of line buffers (i.e., in the vertical direction) is 3, which is equal to the number of pixel rows of the second rectangular pixel region. The product of the number of blocks in the vertical direction of the storage space of the plurality of line buffers and the number of blocks in the horizontal direction of the storage space of the plurality of line buffers is 12.

It should be understood that FIG. 5 is merely for illustrative purposes, which is not intended to limit the scope of the present disclosure. In another embodiment, the acquired pixel rows may be stored as blocks in other manners. In addition, the horizontal and vertical widths of each block may also be changed, which is not limited by the present disclosure.

In one embodiment, the first rectangular pixel region may be the smallest rectangular pixel region for a pixel selection in a first algorithm of a plurality of algorithms, and the second rectangular pixel region may be the smallest rectangular pixel region for a pixel selection in a second algorithm of the plurality of algorithms. The first rectangular pixel region may cover the second rectangular pixel region.

In one embodiment, the first rectangular pixel region and the second rectangular pixel region may be the largest and smallest rectangular pixel regions for the pixel selection in the plurality of algorithms, respectively. In the storage design, both the largest region (e.g., the first rectangular pixel region) and the smallest region (e.g., the second rectangular pixel region) for selecting pixels may be considered, thereby allowing multiple algorithms to share the line buffers.

The present disclosure does not limit the number of rectangular pixel regions to be considered in the storage design. In one embodiment, only one rectangular pixel region may be considered, such as the above-mentioned largest one. In another embodiment, a plurality of rectangular pixel regions may be considered, such as the above-mentioned largest one and smallest one.

In one embodiment, for the second algorithm, the pixels in the corresponding line buffers of the plurality of line buffers may be read according to the second rectangular pixel region, and the corresponding pixels may be selected to be output to a module of the second algorithm (i.e., a second algorithm module). The second algorithm may correspond to the smallest rectangular pixel region, which includes the smallest number of pixels. Thus, the corresponding pixels may be acquired once, then output to the second algorithm module.

In one embodiment, the second algorithm may be Harris algorithm, and the second rectangular pixel region may be a pixel region of 3×3. Taking FIG. 5 as an example, for the first point in the storage space, through merely reading the address 0, address 80, and address 160 of the storage space, 3 rows and 3 columns of pixels (i.e., data) may be selected from the row 0, row 1, and row 2. Through storing in a register, the data may be selected to be output in 3×3 and sent to Harris algorithm for processing.

In one embodiment, for the first algorithm, the read pixels may be registered in a register, i.e., the pixels obtained from multiple read may be registered in the register. The multi-registered pixels which are obtained from multiple read and then registered in the register (i.e., which are registered in the register from multiple read) may be spliced according to the first rectangular pixel region, and corresponding pixels may be selected to be output to a module of first algorithm, i.e., a first algorithm module. Because the first algorithm corresponds to the largest rectangular pixel region, the pixels required for the first algorithm processing may be obtained by splicing the pixels which are obtained from multiple read and then registered in the register, then outputting the spliced pixels to the first algorithm module.

It should be understood that for another algorithm corresponding to a rectangular pixel region which has a size between the second algorithm and the first algorithm, the required pixels may be obtained by splicing the pixels which are registered in the register from multiple read. The first algorithm is explained for illustrative purposes, which is not intended to limit the scope of the present disclosure.

In one embodiment, the first algorithm may be Census algorithm, the rectangular pixel region may be a pixel region of 5×5 or 7×7, and every processing may require 5 rows and 5 columns of pixels or 7 rows and 7 columns of pixels. For illustrative purposes, as shown in FIG. 5, address 0, address 80, address 160 may be first read. It is seen that 12 rows of data may be first read and each row may include 4 pixels, however, such a number of data may be not enough for Census algorithm (5×5 or 7×7). Then the data that was read first may be registered in a register. When the second algorithm (Harris algorithm) reads the address 1, address 81, and address 161, the data previously stored in the register together with the data that is currently read by the second algorithm may be spliced and selected, such that the number of pixels required by the Census algorithm for one processing may be obtained. When the rectangular pixel region is a 13×13 pixel region, the second algorithm (Harris algorithm) may also be desired to read address 3, address 83, and address 163, such that the Census algorithm processing can be performed. In particular, 12 rows of pixels may be self-cached (including: address 0-2, address 80-82, address 160-162), the 13^{th} row of pixels may be derived from the input data, and so on. That is, to process high computational burden algorithms, the data may be started to be processed by the algorithm until the stored data and the read data is determined to include the data required by the algorithm processing.

In one embodiment, the plurality of pixel rows may be acquired by a first input first output (FIFO) manner, through which the data may be stopped from being read after receiving the back pressure, thereby controlling the timing of data reading.

In the disclosed embodiments, a plurality of pixel rows may be stored as blocks in line buffers according to a rectangular pixel region. The number of bits per block in a line buffer may be smaller than the number of pixel columns of the image. Thus, the number of columns of pixels to be read from the line buffer may be smaller than the number of pixel columns of the image, such that the read speed of the data may be increased, and the processing efficiency may be improved accordingly.

Further, through storing the plurality of pixel rows in line buffers according to a plurality of rectangular pixel regions, multiple algorithms may be able to share the line buffers, such that a separate line buffer may be no longer desired to be provided for each algorithm, which reduces the consumption of the storage resources.

The above embodiments describe the technical solution of the storage designs using the line buffer, but the embodiment of the present disclosure is not limited thereto. That is, the storage designs in the foregoing embodiments may be implemented separately, without depending on whether shared or not. In addition, the technical solution of sharing the line buffers provided by the present disclosure may also be implemented separately, without depending on the storage designs in the foregoing embodiments.

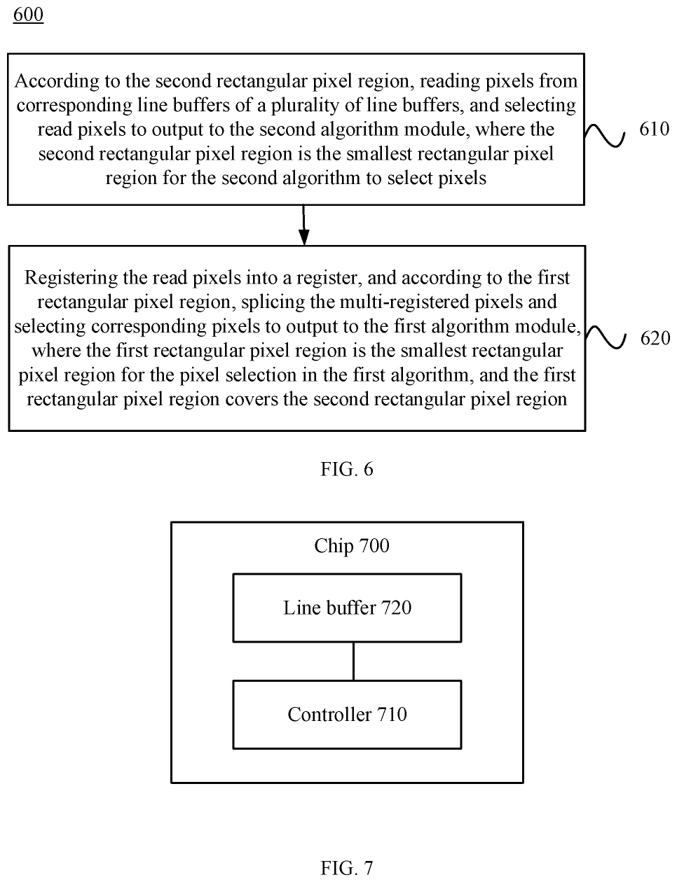

The present disclosure further provides another image processing method, which is described below in conjunction with FIG. 6. It should be understood that some specific descriptions of the method shown in FIG. 6 may refer to the foregoing embodiments, and are not described herein again.

FIG. 6 is flowchart of an image processing method 600 according to another embodiment of the present disclosure. As shown in FIG. 6, the method 600 may include:

Step 610: according to the second rectangular pixel region, reading pixels from corresponding line buffers of a plurality of line buffers, and selecting read pixels to output to the second algorithm module, where the second rectangular pixel region is the smallest rectangular pixel region for the pixel selection in the second algorithm; and

Step 620: registering the read pixels into a register, and according to the first rectangular pixel region, splicing the multi-registered pixels in the register and selecting corresponding pixels to output to the first algorithm module, where the first rectangular pixel region is the smallest rectangular pixel region for the pixel selection in the first algorithm, and the first rectangular pixel region covers the second rectangular pixel region.

In the disclosed embodiments, a plurality of algorithms may share line buffers. In particular, for an algorithm corresponding to a small rectangular pixel region, the pixels required for one processing may be read once from the line buffers. For an algorithm corresponding to a large rectangular pixel region, through registering the read pixels into the register and splicing the multi-registered pixels in the register, the pixels required for one processing may be obtained. Thus, a plurality of algorithms may be able to share the line buffers, and separate line buffers may be no longer desired to be provided for each algorithm, which reduces the consumption of the storage resources.

The present disclosure further provides a chip, a processor, a computer system, and a mobile device. It should be understood that the disclosed chip, processor, computer system, and mobile device may perform any one of the disclosed methods. That is, for the specific working process of the following various products, reference may be made to the corresponding process in the foregoing method embodiments.

FIG. 7 is a schematic block diagram of a chip 700 in accordance with an embodiment of the present disclosure. As shown in FIG. 7, the chip 700 may include a controller 710 and a plurality of line buffers 720. The controller 710 may be configured to acquire a plurality of pixel rows of the image according to the first rectangular pixel region, and store the acquired plurality of pixel rows in the plurality of line buffers 720. In particular, each acquired pixel row may be stored as a block in the storage space of the plurality of line buffers 720, and the number of bits of the block in a line buffer may be smaller than the number of pixel columns of the image.

In one embodiment, the number of the acquired pixel rows may be not less than a difference between the number of pixel rows of the first rectangular pixel region and a preset value.

In one embodiment, the number of the acquired pixel rows may be equal to the number of pixel rows of the first rectangular pixel region minus one.

In one embodiment, the number of blocks in a column of the plurality of line buffers may be equal to the number of pixel rows of the second rectangular pixel region, where the number of pixel rows of the second rectangular pixel region may be smaller than the number of pixel rows of the first rectangular pixel region.

In one embodiment, the number of bits of the block in one of the plurality of line buffers may be not less than the number of columns in the second rectangular pixel region.

In one embodiment, the first rectangular pixel region may be the smallest rectangular pixel region for a pixel selection in a first algorithm of a plurality of algorithms, and the second rectangular pixel region may be the smallest rectangular pixel region for a second algorithm of the plurality of algorithms to select pixels, where the first rectangular pixel region covers the second rectangular pixel region.

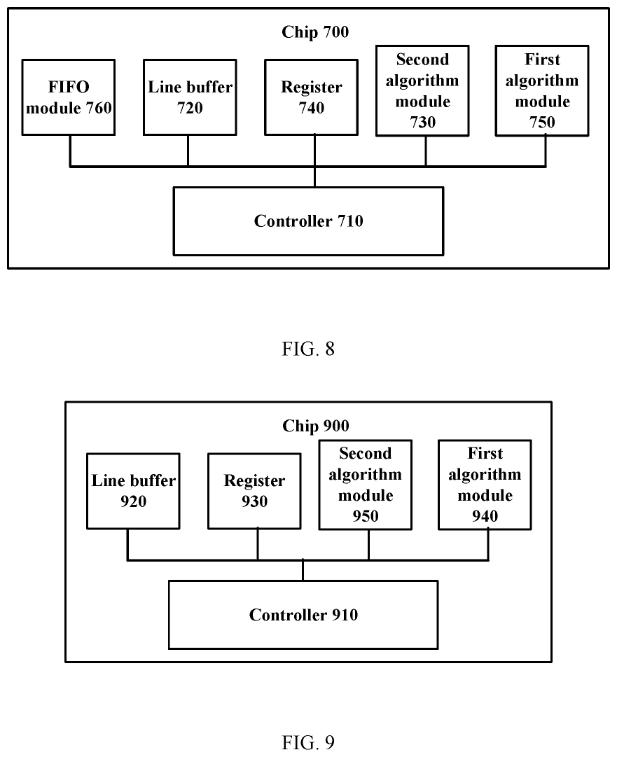

In one embodiment, as shown in FIG. 8, the chip 700 may further include a second algorithm module 730. The controller 710 may be further configured to, according to the second rectangular pixel region, read pixels in corresponding line buffers of the plurality of line buffers 720, and select corresponding pixels to output to the second algorithm module 730.

In one embodiment, as shown in FIG. 8, the chip 700 may further include a register 740 and a first algorithm module 750. The controller 710 may be further configured to register the read pixel into the register 740, and according to the first rectangular pixel region, splice multi-registered pixels in the register 740 and select corresponding pixels to output to the first algorithm module 750.

In one embodiment, the first algorithm may be Census algorithm, and the second algorithm may be Harris algorithm.

In one embodiment, the controller 710 may be configured to store the plurality of pixel rows as a plurality of blocks in the storage space of the plurality of line buffers 720, in an order from top to bottom and from left to right.

In one embodiment, as shown in FIG. 8, the chip 700 may further include a first in first out (FIFO) module 760, and the controller 710 may be configured to acquire pixels of the image through the FIFO module 760. In one embodiment, the chip 710 may be an FPGA or an ASIC.

FIG. 9 is a block diagram of a chip 900 according to another embodiment of the present disclosure. As shown in FIG. 9, the chip 900 may include a controller 910, a plurality of line buffers 920, a register 930, a first algorithm module 940, and a second algorithm module 950. The controller 910 may be configured to read image pixels in the corresponding line buffers of the plurality of line buffers 920 according to the second rectangular pixel region, and select corresponding pixels to output to the second algorithm module 950. The second rectangular pixel region may be the smallest rectangular pixel region for the pixel selection in the second algorithm. The controller 910 may be further configured to register the read pixels into the register 930, and according to the first rectangular pixel region, splice multi-registered pixels in the register 930 and select corresponding pixels output to the first algorithm module 940. The first rectangular pixel region may be the smallest rectangular pixel region for the pixel selection in the first algorithm, and the first rectangular pixel region may cover the second rectangular pixel region.

It should be understood that, in the disclosed chip, the controller may be implemented by a circuit, which may be a single circuit or a circuit composed of several circuits, which is not limited by the present disclosure. It should also be understood that the various units or modules in the embodiments of the present disclosure may be integrated into one chip or distributed in different chips.

The present disclosure also provides a processor, which may include any of the disclosed chips.

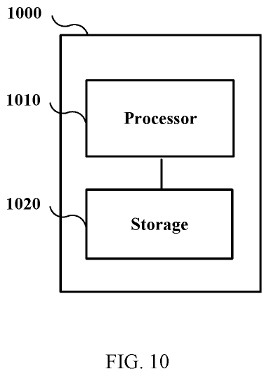

FIG. 10 is a block diagram of a computer system 1000 according to an embodiment of the present disclosure. As shown in FIG. 10, the computer system 1000 may include a processor 1010 and a memory 1020. The computer system 1000 may also include components that are generally included in other computer systems, such as input and output devices, a communication interface, etc., which is not limited by the present disclosure.

The memory 1020 may be configured to store computer executable instructions. The memory 1020 may be any appropriate types of memories, including, for example, a high speed random access memory (RAM), a non-volatile memory such as at least one disk, which is not limited by the present disclosure.

The processor 1010 may be configured to access the memory 1020 and execute the computer executable instructions to perform the operations in the disclosed image processing method. The processor 1010 may include a microprocessor, a field-programmable gate array (FPGA), a central processing unit (CPU), and/or a graphics processing unit (GPU), etc., which is not limited by the present disclosure.

The present disclosure also provide a mobile device, which may include the disclosed chip, processor or computer system.

The disclosed chip, processor, computer system, and mobile device may be corresponding to an execution body of the disclosed image processing method, and the foregoing and other operations and/or functions of the modules in the disclosed chip, processor, computer system, and mobile device are respectively used to implement corresponding procedures of the foregoing methods. For brevity, details are not described herein again.

The present disclosure further provides a computer storage medium. A code is stored in the computer storage medium and configured to execute the disclosed image processing method.

It should be understood that, the term “and/or” in this specification describes only an association relationship for describing associated objects and represents that three relationships may exist. For example, A and/or B may represent the following three cases, only A exists, both A and B exist, and only B exists. In addition, the character “/” in this specification generally represents an “or” relationship between the associated objects.

A person of ordinary skill in the art may be aware that the units and algorithm steps in the examples described with reference to the embodiments disclosed herein may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for convenience and brevity of description, for a detailed working process of the foregoing system, apparatus, and unit, refer to a corresponding process in the foregoing method embodiments. Details are not described herein again.

In the several embodiments provided in the present disclosure, it should be understood that the disclosed system, apparatus, and method may be implemented in other manners. For example, the described apparatus embodiment may be merely exemplary. For example, the unit division may be merely a logical function division and there may be other divisions in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions in the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit may be implemented in a form of a software functional unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in a form of a software product. The computer software product may be stored in a storage medium and may include several instructions for instructing a computer device (which may be a personal computer, a server, or a network device) to perform all or a part of the steps of the methods described in the embodiments of the present disclosure. The foregoing storage medium may include any medium that may store code, such as a universal serial bus (USB) flash drive, a removable hard disk, a read-only memory (ROM), a random-access memory (RAM), a magnetic disk, or an optical disc.

The foregoing descriptions are merely specific implementations of the present disclosure, but are not intended to limit the protection scope of the present disclosure. Any equivalent variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What may be claimed is:

1. An image processing method comprising:
acquiring a plurality of pixel rows of an image according to a rectangular pixel region; and
storing the plurality of pixel rows as blocks in a plurality of line buffers,
wherein a pixel row is stored as a block in a storage space of the plurality of line buffers, and a number of bits of the block in a line buffer is smaller than a number of pixel columns of the image.

2. The image processing method of claim 1, wherein:
a number of the acquired pixel rows is not less than a difference between a number of pixel rows of the rectangular pixel region and a preset value.

3. The image processing method of claim 2, wherein:
the number of the acquired pixel rows is equal to the number of the pixel rows of the rectangular pixel region minus one.

4. The image processing method of claim 1, wherein:
the rectangular pixel region is a first rectangular pixel region,
a number of the blocks in one column of the plurality of line buffers is equal to a number of pixel rows of a second rectangular pixel region, wherein the number of the pixel rows of the second rectangular pixel region is smaller than the number of the pixel rows of the first rectangular pixel region.

5. The image processing method of claim 4, wherein:
the number of bits of the block in the line buffer is not less than a number of pixel columns of the second rectangular pixel region.

6. The image processing method of claim 4, wherein:
the first rectangular pixel region is a smallest rectangular pixel region for a pixel selection in a first algorithm of a plurality of algorithms,
the second rectangular pixel region is a smallest rectangular pixel region for a pixel selection in a second algorithm of the plurality of algorithms, and
the first rectangular pixel region covers the second rectangular pixel region.

7. The image processing method of claim 6, further comprising:
according to the second rectangular pixel region, reading pixels in corresponding line buffers of the plurality of line buffers, and selecting corresponding pixels to output to a second algorithm module.

8. The image processing method of claim 7, further comprising:
registering the read pixels into a register; and
according to the first rectangular pixel region, splicing multi-registered pixels in the register and selecting corresponding pixels to output to a first algorithm module.

9. The image processing method of claim 6, wherein:
the first algorithm is Census algorithm, and the second algorithm is Harris algorithm.

10. The image processing method of claim 1, wherein:
the plurality of pixel rows are stored as blocks, in an order from top to bottom and from left to right in the storage space of the plurality of line buffers.

11. The image processing method of claim 1, wherein acquiring the plurality of pixel rows of the image according to the rectangular pixel region comprises:
acquiring the plurality of pixel rows by a first input first output (FIFO) manner.

12. A chip comprising:
a plurality of line buffers; and
a controller configured to:
acquire a plurality of pixel rows of an image according to a rectangular pixel region, and
store the plurality of pixel rows as blocks in the plurality of line buffers,
wherein a pixel row is stored as a block in a storage space of the plurality of line buffers, and a number of bits of the block in a line buffer is smaller than a number of pixel columns of the image.

13. The chip of claim 12, wherein:
a number of the acquired pixel rows is not less than a difference between a number of pixel rows of the rectangular pixel region and a preset value.

14. The chip of claim 12, wherein:
the rectangular pixel region is a first rectangular pixel region,
a number of the blocks in one column of the plurality of line buffers is equal to a number of pixel rows of a second rectangular pixel region, wherein the number of the pixel rows of the second rectangular pixel region is smaller than the number of the pixel rows of the first rectangular pixel region.

15. The chip of claim 14, wherein:
the number of bits of the block in the line buffer is not less than a number of pixel columns of the second rectangular pixel region.

16. The chip of claim 14, wherein:
the first rectangular pixel region is a smallest rectangular pixel region for a pixel selection in a first algorithm of a plurality of algorithms, and
the second rectangular pixel region is a smallest rectangular pixel region for a pixel selection in a second algorithm of the plurality of algorithms,
wherein the first rectangular pixel region covers the second rectangular pixel region.

17. The chip of claim 16, further comprising:
a second algorithm module,
wherein the controller is further configured to:
according to the second rectangular pixel region, read pixels in corresponding line buffers of the plurality of line buffers, and
selecting corresponding pixels to output to the second algorithm module.

18. The chip of claim 17, further comprising:
a register and a first algorithm module,
the controller is further configured to:
register the read pixels into the register;
according to the first rectangular pixel region, splice multi-registered pixels in the register; and
selecting corresponding pixels to output to the first algorithm module.

19. The chip of claim 16, wherein:
the first algorithm is Census algorithm, and the second algorithm is Harris algorithm.

20. A processor comprising:
a chip comprising a controller and a plurality of line buffers,
wherein the controller is configured to:
acquire a plurality of pixel rows of an image according to a rectangular pixel region, and
store the plurality of pixel rows as blocks in a plurality of line buffers,
wherein a pixel row is stored as a block in a storage space of the plurality of line buffers, and a number of bits of the block in a line buffer is smaller than a number of pixel columns of the image.
